(19) United States
(12) Patent Application Publication
(10) Pub. No.: US 2008/0302710 A1
(43) Pub. Date: Dec. 11, 2008

(54) Pulsating Chlorination Machine

(75) Inventors: Zhanjun Zhang, Zhengzhou (CN); Dongwen Shi, Zhengzhou (CN); Kexin Zhang, Zhengzhou (CN); Chunying Zhao, Zhengzhou (CN); Xiangyang Song, Zhengzhou (CN); Degang Huang, Zhengzhou (CN); Jianyu Zhang, Zhengzhou (CN); Wenhong Wu, Zhengzhou (CN); Ying Lin, Zhengzhou (CN); Wei Zhang, Zhengzhou (CN); Junfeng Sun, Zhengzhou (CN); Yonghong Wang, Zhengzhou (CN); Hongjie Wang, Zhengzhou (CN); Junya Wang, Zhengzhou (CN); Jianhua Yan, Zhengzhou (CN); Xiang Dong, Zhengzhou (CN); Wenjie Mao, Zhengzhou (CN); Ling Shen, Zhengzhou (CN); Feng Shen, Zhengzhou (CN); Xianwu Liu, Zhengzhou (CN)

Correspondence Address: Saul Ewing LLP (Philadelphia), Attn: Patent Docket Clerk, 2 North Second St., Harrisburg, PA, 17101, US

(73) Assignee: Zhanjun Zhang, Zhengzhou (CN)

(21) Appl. No.: 12/134,571

(22) Filed: Jun. 6, 2008

(30) Foreign Application Priority Data
Jun. 8, 2007 (CN) 200710041774.9

(51) Int. Cl. C02F 1/76

(52) U.S. Cl. 210/96.1

(57) ABSTRACT

The invention discloses a pulsating chlorination machine for purification of city water. The machine includes a body, two ends of which are respectively a water inlet and outlet end between which a converging pipe, a throat pipe and a diverging pipe are connected in turn; and a liquefied chlorine input port located below a middle part of the throat pipe and connecting with the throat pipe via a cone-shaped valve seat. A normally closed cone-shaped valve rod is mounted over the cone-shaped valve seat and inserted into the throat pipe through a vertical circular hole on a top of the body, and moves up and down under the control of a pulsating electromagnetic executive mechanism to open/close the liquefied chlorine input port. Through the liquefied chlorine input port the liquefied chlorine flows into the throat pipe and out from the diverging pipe and then into a clear-water reservoir.

### FIELD OF THE INVENTION

The present invention relates to germicidal disinfectant introduction devices for city water supply, and more especially to a pulsating chlorination machine for directly introducing liquefied chlorine.

### BACKGROUND OF THE INVENTION

The method of chlorinating city water is widely acceptable due to sufficient safety and excellent results. In a place where the method is adopted, the rate of infection and death is greatly reduced, and the method is also cost-effective. The method of chlorinating the city water has played a main role by the end of beginning of 21 century.

This disinfectant has a long history. Early in 1835, Dr. Robley Dunglinson suggested that it should use chlorine to treat the city water in his paper published on Human Health in Philadelphia. In 1850, Dr. John Snow utilized chlorine to disinfect the city water after the explosion of cholera. In 1902, a permanent water plant was established by Middlekerke and it was the first plant using chlorine to disinfect the city water in the world. In 1912, Niagara Falls Water Plant used liquefied chlorine to disinfect the city water and also used the equipment for introducing the chlorine which was developed by Dr. Georg Ornstein. This established a good technical basis for modern process of disinfecting the city water.

Currently the process and technique of using chlorine to disinfect the water has been basically matured. All the technical specifications, design handbooks and college textbooks follow the same mode and more newly established water plants also use this mode of introducing chlorine.

The basic features of feeing chlorine process is first vaporizing liquefied chlorine in a cylinder bought from suppliers, then feeding the chlorine gas into the water. The chlorination machine is throttling and uses a throttle valve to adjust the volume of fed chlorine, and realizes continuous introduction.

This throttling chlorination machine can not introduce the liquefied chlorine directly. The first reason is, a part of the liquefied chlorine is certainly vaporized during the throttling process and another part of the liquefied chlorine is frozen due to absorbing heat, which causes passage jam of the throttle valve. It is supposed that the jam can be solved by adding heating device, but there is another problem, i.e. because the specific gravity of the liquefied chlorine is far greater than that of chlorine gas, the opening of the throttling valve will be smaller if it is introduced with the liquefied chlorine. At this point, passages of the throttling valve can be subject to be clogged by the solid impurity particles in the liquefied chlorine. In addition, the adjusting accuracy will be affected if the opening of the throttling valve is too small, which disadvantages controlling the operation. In actual operation, it will be regarded as accident if the liquefied chlorine by chance enters the machine which needs immediate examination and cleaning, even replacing components.

Traditional chlorination machines have two types: manual chlorination machines (suitable for small water plants) and automatic chlorination machines (suitable for middle and large water plants). The drawback of the manual chlorination machines is that it is difficult to introduce accurate amount of chlorine and the drawback of the automatic chlorination machines is expensive cost, high cost for operation, complicated, subjected to malfunction, and hard for maintenance.

To promote the progress of technique of city water supply, Tian quan Zhang et al. have studied the process of introducing chlorine for a long time. In 2004. Filed an invention patent application CN200410010109X entitled System and device of Direct Introducing Process of Liquid Chlorine. Meanwhile, two utility model patent applications entitled System of Direct Introducing Process of Liquid Chlorine CN200420010315.6 and Feeder of Liquid Chlorine (Patent No. ZL200420010316.0) are filed and granted for Certificates of Patent. In addition, a US patent application entitled Direct Chlorination System and Device of City Water (U.S. application Ser. No. 11/070,735) is filed in March 2005. The core technique of the above mentioned four patents/applications is that the expensive automatic gaseous chlorine chlorination machine is replaced with a reciprocating diaphragm metering pump and expensive liquid chlorine evaporator is removed, which realizes direct introducing of liquid chlorine, greatly reduces investment and operation cost and improves the accuracy of introducing chlorine. The key mechanism is that discontinuous pulsating introducing replaces the former continuous throttling introducing.

### SUMMARY OF THE INVENTION

An objection of the present invention is to provide a pulsating chlorination machine which can directly introduce liquefied chlorine into city water and has a simple structure and high security and work stability.

Actually, present invention is an improvement of Direct Chlorination System and Device for City Water (CN 200410010109.8). The main points of the improvement are as follow: withdraw the diaphragm metering pump 9, electromotor 10, variable frequency regulator cabinet 11, and the precipitating cylinder of liquefied chlorine 6. Also we improve on the liquefied chlorine feeder 13 and make it has the function of diaphragm metering pump 9 at the same time.

The operation principles after improvement are as follow:

According to the varied requirement of feeding chlorine, the ED automatic control 62 drive the pulsating electromagnetic executive mechanism 13 with pulsating current (DC24V), to moving state of the normally closed cone-shape valve rod 7 open or close the input port of liquid chlorine 16 of pulsting chlorination machine. Thereby controlling the amount of chlorine introduced.

But there are two difficulties in this improvement:

The first one is: the pressure of liquefied chorine in cylinder is low as the temperature becomes low in winter (such as: the pressure is 0.27 MPa at 0° C.), but the pressure in pressure pipeling is still 0.3 MPa, the result is that the liquefied chorine can't flow into a higher pressure container from a lower pressure container. Aim to this problem, the means of settlement is: (1) greatly reducing the diameter of throat pipe of the water passage in feeder, thus increasing the water velocity in it, and make the static pressure of water in throat pipe become negative pressure (about −0.02 MPa gauge pressure); (2) try to make the height of liquefied chorine cylinder higher than the height of pulsating machine, such as 2m.

The second one is: if the pressure in liquefied chorine pipeling is lower than pressure in cylinder, liquefied chorine would immediately vaporize, thereby causing endothermal and freezing to clogging the pipeling. Aim to this problem, the means of settlement is: (1) to use the liquefied chorine pipeling with bigger diameter and shorter in length, so it can reduce the liquid flow resistance; (2) to choose the suitable moving frequency of valve rod of pulsating machine, ensure the maximum opening of valve, as well as control the current frequency and electric duct ratio (ED), called duty ratio (P/B or Pulse/Bar), thus make the water resistance mainly focus on the gap of pulsating machine, when the liquefied chorine flows.

Note: the technique feature of pulsating flow is different from steady flow. When the liquefied chorine flows steadily in pipeling, as long as the pressure in liquefied chorine pipeling is lower than liquefied pressure in cylinder, it would immediately vaporize, thereby causing rapid temperature reduction and freezing, accordingly clogging the pipeling. But when the liquefied chorine keeps pulsating flow in pipeling, the liquefied chorine fluctuates at low pressure, although its pressure is lower than the pressure in liquefied cylinder, it would not immediately vaporize and cause freezing, and the pressure increases instantly. This physical feature is favorable for this invention, so we should make use it fully.

To achieve the above-mentioned object, a pulsating chlorination machine in accordance with the present invention is disclosed. The pulsating chlorination machine includes a chlorination machine body, two ends of which are respectively a water inlet end and a water outlet end between which a converging pipe, a throat pipe and a diverging pipe are connected in turn; and a liquefied chlorine input port located below a middle part of the throat pipe and connecting with the throat pipe via a cone-shaped valve seat which is the last gate of liquefied chlorine being introduced into the throat pipe. A normally closed cone-shaped valve rod is mounted over the cone-shaped valve seat and inserted into the throat pipe through a vertical circular hole on a top of the chlorination machine body, and moves up and down under the control of a pulsating electromagnetic executive mechanism to open/close the liquefied chlorine input port. The pulsating electromagnetic executive mechanism achieves the purpose of adjusting amount of introduced chlorine in time via a residual chlorine current signal circuitry varying electric duct ratio at any moment.

Basing on the above structure, pressurized water for water plant use flows into the converging pipe and then the throat pipe in which flow rate of the water greatly increases and a slight vacuum is formed. When the normally closed cone-shaped valve rod opens the liquefied chlorine input port, liquefied chlorine flows through the liquefied chlorine input port into the throat pipe and mixes with the water to form a high concentration chlorine solution which flows out from the diverging pipe and finally into a clear-water reservoir. The process of introducing chlorine is finished. Accordingly, the pulsating chlorination machine can directly introduce liquefied chlorine into city water and has a simple structure and high security and work stability.

The normally closed cone-shaped valve rod only stops at a highest position and a lowest position and won't stop at any middle position. When the pulsating electromagnetic executive mechanism is switched on, a cone-shaped end of the normally closed cone-shaped valve rod stays at the highest position to open the liquefied chlorine input port; and when the pulsating electromagnetic executive mechanism is switched off, the cone-shaped end of the normally closed cone-shaped valve rod stays at the lowest position to close the liquefied chlorine input port.

The cone-shaped valve seat connects the liquefied chlorine input port with the throat pipe and matches the cone-shaped end of the normally closed cone-shaped valve rod in shape.

When the cone-shaped end of the normally closed cone-shaped valve rod stays at the lowest position, two arc-shaped water passage cross sections are formed at both sides of the normally closed cone-shaped valve rod, respectively, so the normally closed cone-shaped valve rod won't completely plug up the water passage cross sections of the throat pipe.

Because the liquefied chlorine is an unstable flow (a pulsating flow), water hammer phenomenon is possible to occur (that is, pressure increases or reduces sharply). So the pulsating electromagnetic executive mechanism disposes a damping device therein to reduce the moving speed of the normally closed cone-shaped valve rod, thereby avoiding the water hammer phenomenon.

The liquefied chlorine input port connects with a liquefied chlorine pipeline for chlorination machine inlet on which a check valve is mounted to prevent the water in the throat pipe from flowing backwards into the source liquefied chlorine cylinder.

A gland packing ring is disposed surround the normally closed cone-shaped valve rod in the passage to prevent the liquid in the throat from leaking and outside air entering.

### BRIEF DESCRIPTION OF THE DRAWINGS

FIG. 1 is a sectional view of a pulsating chlorination machine according to the present invention, wherein a normally closed cone-shaped valve rod is located at a probable highest position;

FIG. 2 is a sectional view taken along the line A-A of FIG. 1, when the normally closed conical valve rod is located at a lowest position; and

FIG. 3 illustrates the overall chlorination system.

### DETAILED DESCRIPTION OF THE EMBODIMENT

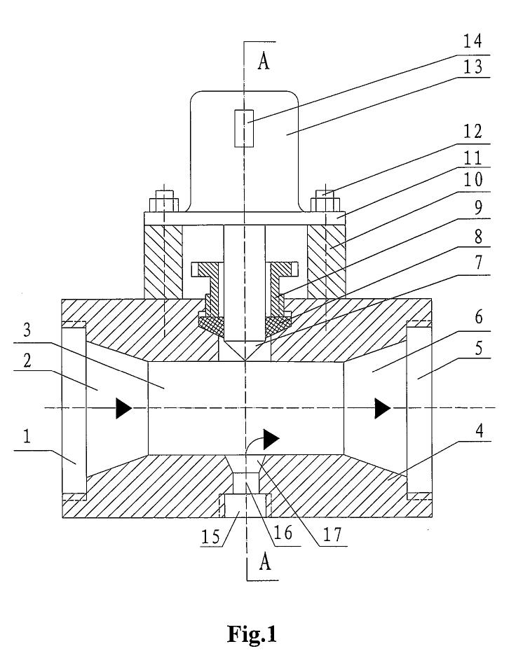

To further understand functions and features of the present invention, please refer to the following preferred embodiment related the present invention and detailed description according to FIGS. 1-3.

As shown in FIG. 1, a chlorination machine body 4 has inlet pipe threads 1 and outlet pipe threads 5 on two ends thereof, and the inlet pipe threads 1 engage with a pressurized water pipe for a water plant. Pressurized water flows into a converging pipe 2 and then a throat pipe 3 in which flow rate of the water greatly increases, water pressure is reduced and a slight vacuum is formed, that is, the pressure is slightly lower than atmosphere pressure. Beneath a middle part of the throat pipe 3, liquefied chlorine may be introduced into the throat pipe 3 and mix with the water to form a high concentration chlorine solution which finally flows out from a diverging pipe 6.

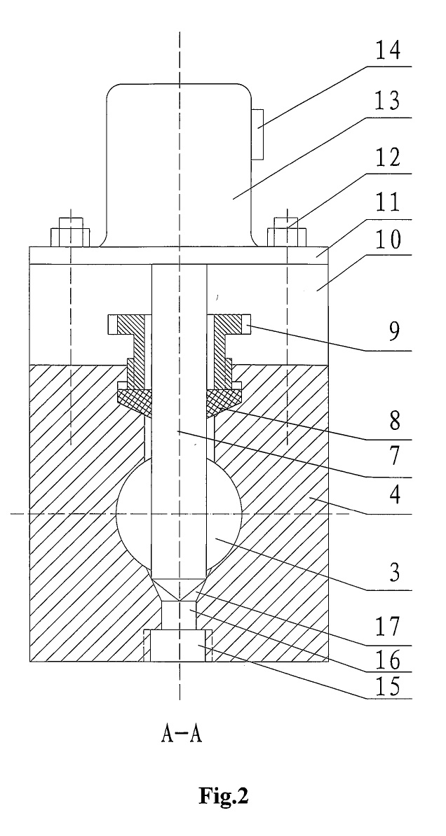

The body 4 has a liquefied chlorine input port 16 below the middle part thereof, which connects with the throat pipe 3 via a cone-shaped valve seat 17. The cone-shaped valve seat 17 is the last gate through which the liquefied chlorine is introduced into the throat pipe 3. The body 4 disposes a normally closed cone-shaped valve rod 7 on the middle part thereof, which is inserted into the throat pipe 3 through a vertical circular hole on a top of the chlorination machine body 4. Under the control of a pulsating electromagnetic executive mechanism 13, the normally closed cone-shaped valve rod 7 may move up and down vertically, and only stop at the highest position and the lowest position and won't stop at any middle position. When the normally closed cone-shaped valve rod 7 stays at the highest position as shown in FIG. 1, the liquefied chlorine maintained under pressure may flow into the throat pipe 3 through the cone-shaped valve seat 17. When the normally closed cone-shaped valve rod 7 stays at the lowest position as shown in FIG. 2, a cone-shaped end of the normally closed cone-shaped valve rod 7 presses against the cone-shaped valve seat 17 to make the liquefied chlorine maintained under pressure stop flowing into the throat pipe 3.

The liquefied chlorine input port 16 is a circular hole. Liquefied chlorine introduction pipe threads 15 engage with a liquefied chlorine pipeline. A gland packing ring 8 is disposed surround the normally closed cone-shaped valve rod 7 to isolate the liquid in the throat pipe 3 from air outside the chlorination machine. A cover 9 compresses the gland packing ring 8. A supporting block 10 supports the pulsating electromagnetic executive mechanism 13. A base 11 and the pulsating electromagnetic executive mechanism 13 are formed integrally. The base 11 and the supporting block 10 are connected to the chlorination machine body 4 via double-end bolt and nuts. A pulsating current leading-in box 14 is mounted on the pulsating electromagnetic executive mechanism 13.

As shown in FIG. 2, when staying at the lowest position, the normally closed cone-shaped valve rod 7 won't completely plug up a water passage cross section of the throat pipe 3. At this time, two arc-shaped water passage cross sections are formed at both sides of the normally closed cone-shaped valve rod 7, respectively. So during the whole process of operation, the water passing through the throat pipe 7 won't be cut off. Of cause, flow rate of the water will fluctuates. As shown in FIG. 1, when the normally closed cone-shaped valve rod 7 stays at the possible highest position, the water passage cross sections of the throat pipe 3 are completely clear.

It should be pointed out that an actual setting highest position of the normally closed cone-shaped valve rod 7 may not always ensure that the water passage cross sections are completely clear, as shown in FIG. 1. At the actual setting highest position, the cone-shaped top end of the normally closed cone-shaped valve rod 7 may be lower than the highest point of inside diameter of the throat pipe 3, that is, even if staying at the highest position, the normally closed cone-shaped valve rod 7 may occupy partial water passage cross section of the throat pipe 3. So that the up-and-down displacement of the normally closed cone-shaped valve rod 7 can be shortened, and the liquefied chlorine can dissolve in the water in the throat pipe 3 more easily, quickly and evenly after flowing into the throat pipe 3. But when the normally closed cone-shaped valve rod 7 stays at the highest position, the size of gap between the top end of the valve rod 7 and the cone-shaped valve seat 17 should be larger than or equal to inside diameter of the liquefied chlorine input port 16.

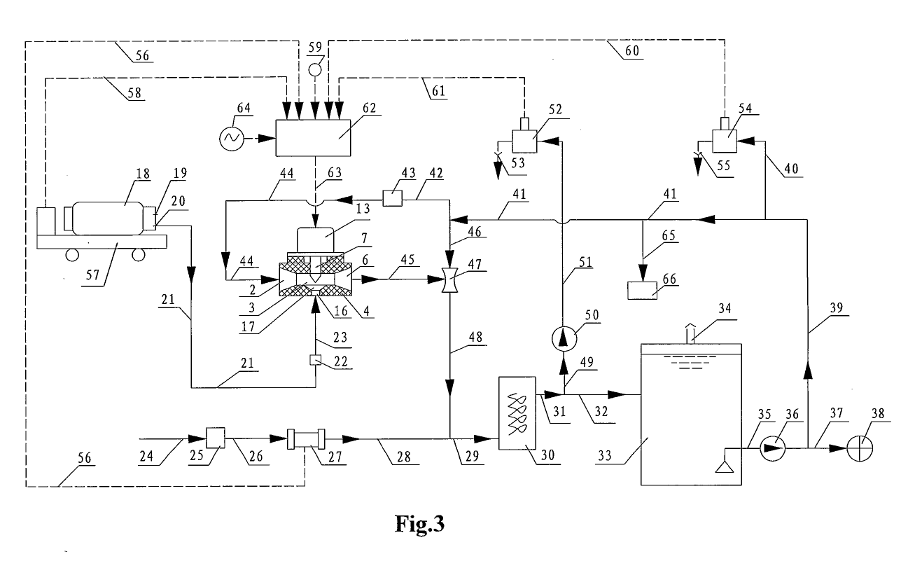

FIG. 3 illustrates the overall chlorination system. As shown in FIG. 3, the liquefied chlorine from a source liquefied chlorine cylinder 18 flows out from a source chlorine cylinder valve 20 at a bottom portion of the cylinder 18 (when a standby chlorine cylinder valve 19 is used, the source liquefied chlorine cylinder 18 is turned 180 degree), passes through a liquefied chlorine pipeline for cylinder outlet 21, a check valve 22, a liquefied chlorine pipeline for chlorination machine inlet 23 to the liquefied chlorine input port 16 below the middle part of the pulsating chlorination machine. Herein, when the normally closed cone-shaped valve rod 7 stays at the highest position, the liquefied chlorine flows into the throat pipe 3 through the cone-shaped valve seat 17 depending on self pressure, is flushed into the diverging pipe 6 by the water and passes through a high concentration chlorine solution pipe 45 into a water injector 47. During operation, since the high concentration chlorine solution pipe 45 is under a vacuum state of which the pressure is slightly lower than atmosphere pressure, the high concentration chlorine solution cannot leak into atmosphere, and even when the pipelines is out of function, only air leak into the pipelines. At this time, the pressurized water from an inlet pipe for water injector 46 flows into the water injector 47 too. Here, the pressurized water becomes negative pressure water after jetting, and then mixes with the high concentration chlorine solution, thereby the high concentration chlorine solution is diluted to be low concentration chlorine solution. After passing through a diverging pipe of the water injector 47, the low concentration chlorine solution is under a positive pressure and flows into an outlet pipe for flow meter 28 through a low concentration chlorine solution pipe 48. During operation, the pressure in the low concentration chlorine solution pipe 48 is slightly higher than that in the outlet pipe for flow meter 28, and both of them are higher atmosphere pressure.

When the normally closed cone-shaped valve rod 7 stays at the lowest position, stop introducing the chlorine. However, the water still keeps passing through the throat pipe 3. At this moment, the water in the throat pipe 3 passes through the two arc-shaped water passage cross sections at both sides of the normally closed cone-shaped valve rod 7.

After introducing the chlorine, filtered water passes through an inlet pipe for mixing basin 29 to a mixing basin 30, and then flows through an outlet pipe for mixing well 31 and an inlet pipe for clear-water reservoir 32 into a clear-water reservoir 33 on which a vent hole 34 is disposed. Herein, the chlorine and the water react fully for disinfection purpose thereby forming city water, and finally the city water is led to a city water distribution network 38 through an inlet pipe for water delivery pump 35, a water delivery pump 36 and an outlet pipe for water delivery pump 37.

Through pulsating introducing chlorine is continued by intervals, chlorine content in the water in the clear-water reservoir 33 will not be different in different time or positions. The reason is that the cycle of the pulsating introducing chlorine is very short (less than one minute) and the chlorine is very easy to dissolve in the water and diffuses quickly. The principle likes that of an AC incandescent lamp which has variable current but same luminance. After chlorine introduction, the content ratio of the water and the chlorine in the high concentration chlorine solution pipe 45 is about 1000:1. After dilution by the water injector 47, the content ratio of the water and the chlorine in the low concentration chlorine solution pipe 48 is about 10000:1. After the low concentration chlorine solution is fed into the outlet pipe for flow meter 28, the content ratio of the water and the chlorine in the inlet pipe for mixing basin 29 is about two millionths. The volume of the clear-water reservoir 33 is about one tenth of the total water supply per day in a water plant, which is a very large amount. So the clear-water reservoir 33 has a good buffer function and may ensure that residual chlorine content in the city water from the water delivery pump 36 is very stable and about one millionth.

The system as shown in FIG. 3 further includes a pressurized water main pipe for water plant use 39, an inlet pipe for city water detector 40, a pressurized water pipe for water plant use 41, a source pipe for chlorination machine 42, a hydraulic pressure retaining valve 43, an inlet pipe for chlorination machine 44, a special pressurized water pipe 65 and other departments 66 (such as alum dosing, landscaping, offices etc.) in the water plant, wherein the hydraulic pressure retaining valve 43 ensures that hydraulic pressure behind the valve 43 keeps on about 0.25 MPa.

The chlorination machine is an automatically controlled machine. A main control signal comes from the outlet pipe for mixing well 31. A sampling pump 50 pumps water from the outlet pipe for mixing well 31 via an inlet pipe for sampling pump 49 and delivers the water to a residual chlorine continuous detector 52 via an outlet pipe for sampling pump 51. A drainage funnel 53 of a chlorination continuous detector 52 is behind the residual chlorine continuous detector 52. The residual chlorine continuous detector 52 sends out a 4-20 mA continuous current signal which indicates level of residual chlorine in chlorination water sampling. The current signal is transmitted to an electric duct ratio (ED) automatic control adjustor 62 via a residual chlorine current signal circuitry 61 (4-20 mA). Herein, compare the instantaneous current value from the residual chlorine current circuitry 61 with a predetermined standard current value to decide to increase or reduce ED of power current from the ED automatic control adjustor 62. If the instantaneous current level is lower than the predetermined standard current value, ED needs to be increased, and vice versa. Pulsating current from the Ed automatic control adjustor 62 flows through a pulsating current circuitry (DC24V) 63 to the pulsating electromagnetic executive mechanism 13. The pulsating electromagnetic executive mechanism 13 determines the moving state of the normally closed cone-shaped valve rod 7 thereby controlling the amount of chlorine introduced.

A secondary control signal comes from a flow meter 27 for the filtered water, which is behind an outlet pipe for rapid water filter 26. An inlet pipe for rapid water filter 24 is an outlet pipe for precipitating basin in the water plant. When water yield of the rapid water filter 25 increases or reduces, the flow meter 27 instantly changes the current signal which is transmitted to the ED automatic control adjustor 62 via a current signal circuitry for flow rate of filtered water 56 (4-20 mA). The transmission of the instant signal is ahead of that of the signal from the residual chlorine continuous detector 52, thereby the ED automatic control adjustor 62 instantly properly adjusts ED of the pulsating current (actually adjusts the amount of the introduced chlorine) to prevent the amount of chlorine in the filtered water from having too much fluctuation. Through the secondary signal control system can improve the adjust function, the control device becomes more complicated. The current signal circuitry for flow rate of filtered water 56 and the corresponding devices can be omitted to save investment cost.

An electronic scale 57 sends out a current signal (4-20 mA) to indicate an actual consume rate of the liquefied chlorine in the source liquefied chlorine cylinder 18, through which if the chlorination system works normally may be monitored. The current signal is transmitted to the ED automatic control adjustor 62 via a current signal circuitry for weight of source chlorine cylinder (4-20 mA) 58. The ED automatic control adjustor 62 determines if the introduction of chlorine stops and if a warning signal needs to be sent out, according to a predetermined programmer. The current signal circuitry for weight of source chlorine cylinder 58 and the corresponding devices can be omitted to save investment cost.

A residual chlorine continuous detector for city water 54 sends out a current signal which is transmitted to the ED automatic control adjustor 62 via a current signal circuitry for amount of residual chlorine in city water 60 (4-20 mA). The ED automatic control adjustor 62 sends out a “work normally” signal or a “work abnormally” signal, etc., according to a predetermined programmer, and if necessary, reports the detailed amount of the residual chlorine which is convenient for taking measures in time to ensure water quality of the city water. Water samples that the residual chlorine continuous detector for city water 54 detects come from the inlet pipe for city water detector 40 which connects with the pressurized water main pipe for water plant use 39. Since the pressurized water main pipe for water plant use 39 has a large diameter and water in the main pipe 39 has a high flow rate, it may ensures that the water samples are correctly provided in time. The residual chlorine continuous detector for city water 54 connects to a drainage funnel 55 of a city water detector. The residual chlorine continuous detector for city water 54 and the corresponding devices can be omitted to save investment cost.

When related current signal circuitries or devices are out of order, ED may be set by operating a manual knob for setting electric duct ratio (ED) 59 by hand. Actually, what is set is the amount of the chlorine introduced. In the normal states, the manual knob for setting ED 59 doesn't work. The manual knob for setting ED 59 is a necessary device and cannot be omitted.

The frequency of power supply (AC220) 64 is 50 Hz.

The following is to describe several key technologies.

As shown in FIG. 1, the normally closed cone-shaped valve rod 7 may move reciprocatingly in the vertical direction under the control of the pulsating electromagnetic executive mechanism 13. The pulsating electromagnetic executive mechanism 13 has electromagnetic coils therein, which may exert upward traction force. When the power supply is cut off, no traction force exists, a spring in the pulsating electromagnetic executive mechanism 13 presses the normally closed cone-shaped valve rod 7 to the lowest position, and the highest upward pressure of the liquefied chlorine may be overcome, so that the cone-shaped end of the normally closed cone-shaped valve rod 7 presses against the cone-shaped valve seat 17 and the introduction of chlorine stops. When the power supply is switched on, the upward traction force exerted by the electromagnetic coils is larger than a downward thrust force exerted by the spring. So that the normally closed cone-shaped valve rod 7 is pulled to the highest position and a gap is formed between the normally closed cone-shaped valve rod 7 and the cone-shaped valve seat 17. The liquefied chlorine flows through the gap into the throat pipe 3, and the process of introducing the liquefied chlorine starts.

From the point of introducing the liquefied chlorine, the ratio of the duration of the normally closed cone-shaped valve rod 7 staying at the highest position and the total duration of the normally closed cone-shaped valve rod 7 staying at the highest position and the lowest position is called duty ratio (P/B or Pulse/Bar) which is expressed as a percentage.

From the point of turning off/on the electromagnetic coils, the ratio of electrify time and the total time of electrify time and break time of the electromagnetic coils is called Electric Duct Ratio (ED). ED may be expressed as the following equation:

Electric Duct Ratio (ED) %=electrify time/(electrify time+break time)×100

In the present invention, Pulse/Bar is completely equal to Electric Duct Ratio in value. The amount of the introduced liquefied chlorine can be adjusted via changing Electric Duct Ratio.

During a pulsating process, the sum of the electrify time and the break time is considered as a cycle which may be predetermined as a fixed value (such as ten seconds, thirty seconds etc.), and the electrify time in the cycle (that is, the duration of introducing chlorine) is a variable, which indicates a variation of the amount of the introduced chlorine. This is the work mechanism of the chlorination machine controlling the amount of the introduced chlorine.

The longer the predetermined pulsating cycle is, the lower the movement frequency of the normally closed cone-shaped valve rod 7 is and the less mechanical wear is. However, uniformity of chlorination is lower. The shorter the predetermined pulsating cycle is, the higher the movement frequency of the normally closed cone-shaped valve rod 7 is and the higher uniformity of chlorination is. However the mechanical wear is worse. So the optimal cycle may be determined by experiment. In the present invention, both service life of the normally closed cone-shaped valve rod 7 and the uniformity of chlorination have wide selection ranges.

Therein haven' any difficulty in technology.

It should be pointed out that a concrete value of Pulse/Bar or ED cannot completely determine the amount of the introduced chlorine. In fact, the concrete amount of the introduced chlorine is dependent on pressure in the source liquefied chlorine cylinder 18, pressure in the throat pipe 3, resistance of the liquefied chlorine pipeline for cylinder outlet 21 etc., and viscosity of the liquefied chlorine and impurity in the liquefied chlorine etc. However, the above factors are constant or have a little change in a short term, so only adjusting ED in time can instantly amount the quantity of the liquefied chlorine. In a long term, even when some factors change greatly (for example, the pressure in the source liquefied chlorine cylinder), chlorination efficiency isn't affected. The reason is that the residual chlorine continuous detector 52 instantly transmits the value of the residual chlorine to the ED automatic control adjustor 62. The final feedback signal may lead the ED automatic control adjustor 62 to adjust ED to provide needed liquefied chlorine in accordance with specific conditions, and effects caused by the above extra factors may be eliminated. It's unnecessary and impossible to establish a corresponding functional relationship between the ED (or Pulse/Bar) and the amount of the introduced chlorine.

The pulsating chlorination machine has a water passage which is “converging pipe 2→throat pipe 3→diverging pipe 6”, that is, a Venturi Tube. The throat pipe 3 forms a slight vacuum of 0.02 MPa therein. In any season, including in winter, the liquefied chlorine may still be successfully introduced into the throat pipe 3, even when the liquefied chlorine in the source liquefied chlorine cylinder 18 has the lowest temperature and the lowest pressure. The following table shows the relationship between the pressure and the temperature in the source liquefied chlorine cylinder 18 (when liquid phase and air phase coexist):

| | Temperature of the liquefied chlorine ° C. | | | | | | | | |
|---|---|---|---|---|---|---|---|---|---|
| | 50 | 40 | 30 | 20 | 10 | 0 | −10 | −20 | −34 |
| Corresponding pressure MPa | 1.3 | 1.02 | 0.78 | 0.56 | 0.42 | 0.27 | 0.2 | 0.1 | 0 |

For example, the total water supply in a water plant is 300000 m3 per day, and the maximum amount of introduced chlorine is 45 kg/h. Two pulsating chlorination machines of the present invention are chosen, and one pulsating chlorination machine works and the other is on standby. Rated amount of introduced chlorine of each pulsating chlorination machine is 0-50 kg/h. The lowest temperature during introducing chlorine is −8° C. The lowest temperature of liquefied chlorine in the cylinder is −10° C., so according to the above table, the corresponding pressure in the cylinder is 20 meters of water-column or 13 meters of liquefied chlorine column pressure (specific gravity of liquefied chlorine is 1.525 kg/L ). The pressure in the throat pipe 3 of the chlorination machine is approximate to 0.

The maximum instantaneous volume of introduced chlorine of a pulsating chlorination machine is:

45÷1.525÷3600÷0.8=0.01 L/s

In the above equation, EDmax=80%=0.8 (EDmax is the maximum ED).

Adopt a red copper pipe with an inside diameter of Φ6 to delivery the liquefied chlorine. The maximum flow rate is 0.39 m/s, that is, Vmax=0.39 m/s, and the liquefied chlorine is an unstable flow. It is estimated that resistance caused by a red copper pipe of ten extended meters is 10 meters of water-column, which is lower than the difference (20 meters of water-column) between the pressure in the cylinder and the pressure in the throat pipe. If it is founded that resistance of the red copper pipe is higher than the estimated resistance, a red copper pipe with an inside diameter of Φ8 may be selected.

A main pipe of liquefied chlorine inlet pipes of a large pulsating chlorination machine is a steel pipe with a diameter of Φ10˜Φ15. A plurality of liquefied chlorine branch pipes with diameters of Φ6˜Φ8 are connected in parallel at the source liquefied chlorine cylinder 18 and supply liquefied chlorine for the main pipe, and then the main pipe deliveries the liquefied chlorine to the chlorination machine.

A pulsating chlorine introducing graph cannot be a discontinuous rectangle and only may be a discontinuous trapezoid. It is because the normally closed cone-shaped valve rod 7 has a certain mass inertia, which causes that either the upward electromagnetic traction force or the downward thrust force of the spring cannot make the normally closed cone-shaped valve rod 7 have infinite acceleration. So, in the pulsating chlorine introducing process, the amount of introduced chlorine cannot change suddenly. Accordingly, if water hammer phenomenon in the liquefied chlorine pipeline for cylinder outlet 21, the check valve 22, the liquefied chlorine pipeline for chlorination machine inlet 23, the liquefied chlorine input port 16, the cone-shaped valve seat 17 and so on occurs is completely dependent on mass of the normally closed cone-shaped valve rod 7, the electromagnetic traction force, the thrust force of the spring, and friction caused by objects contacting with the normally closed cone-shaped valve rod 7. It is considering that the liquefied chlorine pipeline for cylinder outlet 21, the check valve 22, the liquefied chlorine pipeline for chlorination machine inlet 23, the liquefied chlorine input port 16 and the cone-shaped valve seat 17 all have small caliber and the liquefied chlorine pipeline for cylinder outlet 21 and the liquefied chlorine pipeline for chlorination machine inlet 23 isn't too long, so the possibility that water hammer phenomenon appears is very small. If water hammer is serious in an experiment, the pulsating electromagnetic executive mechanism 13 may add a damping device therein to reduce the moving speed of the normally closed cone-shaped valve rod 7. Since the maximum fullness degree of liquefied chlorine in the source liquefied chlorine cylinder 18 only is about 85%, water hammer phenomenon cannot occur in the source liquefied chlorine cylinder 18.

If the water injector 47 or the low concentration chlorine solution pipe 48 is clogged and the hydraulic pressure retaining valve 43 is out of order, pressure in the pressurized water main pipe for water plant use 39 may reach to 0.3-0.4 MPa, and water pressure in the throat pipe 3 may be higher than the pressure in the source liquefied chlorine cylinder 18 (the pressure in winter is about 0.2-0.27 MPa), so that the pressurized water in the throat pipe 3 may flow backwards into the source liquefied chlorine cylinder 18 and related liquefied chlorine pipelines, which is very danger and must be prohibited. For this reason, the check valve 22 is mounted on the liquefied chlorine pipeline for chlorination machine inlet 23 in front of the liquefied chlorine input port 16.

During operation, if the pressurized water flows backwards into the cylinder and related pipelines, the cylinder should be unloaded and pushed into the precipitating basin to discharge the liquefied chlorine therein completely, and then a pressurization test should be done to determine if the cylinder is abandoned, according to regulations. It is same to the related pipelines. The pressurized water flowing into the cylinder cannot completely corrode the cylinder in a short term.

Power-cut chlorine room will affect normal production in a water plant. So a power supply circuitry for the chlorine room should be a double-loop with different outdoor directions and routes. A power supply for the chlorine room is suitable to connect with a power supply for a water delivery pump station in parallel. Furthermore, standby power supplies such as storage batteries, UPS and so on may be adopted for secure operation of the chlorination system. In some very infrequent situations that the power supply for the water delivery pump works normally and the above secure measures all lose efficacy, the introduction of chlorine may be carried out by manual devices on the pulsating electromagnetic executive mechanism 13 on the basis of experience and the power supply need be recovered as soon as possible.

If there are solid impurity particles in the liquefied chlorine, it is possible that the impurity particles are locked between the normally closed cone-shaped valve rod 7 and the cone-shaped valve seat 17 when the normally closed cone-shaped valve rod 7 moves downward to the cone-shaped valve seat 17. The situation won't bring about operation troubles. The reason is that in a next cycle, the impurity particles are certain to be swept by the liquefied chlorine when the normally closed cone-shaped valve rod 7 stays at the highest position. The normally closed cone-shaped valve rod 7 and the cone-shaped valve seat 17 are made of corrosion resistant and wearproof material and cannot be damaged by occasional clogging of impurity particles.

That the liquefied chlorine is introduced into water will produce endothermic effect. Because the content ratio of the water and the chlorine passing through the chlorination machine is very high (about 1000:1) and the lowest temperature of water for water plant use is about 0.2° C., so ice dregs cannot be formed in the pipelines, which avoids clogging of the pipelines.

The pulsating chlorination machine of the present invention has reference numbers 1-17 for its components and positions thereof. The core feature of the present invention refers to the components with reference numbers 1-9 and 15-17, which is designed by the inventor(s) and outsourced by designated supplier/manufacturer. The manufacturing cost is low because that geometrical shape of the components has no cute angles, has a size smaller than 5 mm, and has a relatively low demand for manufacture. The pulsating electromagnetic executing mechanism 13 is adapted from driving means of electromagnetic valves on the market. The ED automatic control adjustor 62 needs to be ordered from relevant manufacturers based on specific technical requirements, which is widely on market and not patented product. The ED automatic control adjustor 62 and the pulsating electromagnetic executing mechanism 13 can be integrally formed with each other when the products are manufactured in batches. The check valve 22 is accessories of a reciprocating diaphragm metering pump and can be bought from manufacturers. Other equipments can be purchased on the market wherein many of equipments and facilities are from the original facilities.

The present invention can be used to introduce chlorine gas, the advantage of which is having a high accuracy of introducing chlorine, good resistance to wearing, and the passage for introducing chlorine will not be clogged even if liquefied chlorine containing solid impurity particles enters by chance. The drawback is that a reliable power source is needed. The present invention is not suitable for small water plants.

The preferred embodiment related the present invention is described above thereby those skilled in the art make use of the present invention. Those skilled in the art may make various changes of the preferred embodiment depending on the principles of present invention. It will be understood that what is disclosed above is only the preferred embodiment of the present invention and various equivalent changes of the present invention are without departing from the scope of the present invention.

What is claimed is:

1. A pulsating chlorination machine, comprising a chlorination machine body, two ends of which are respectively a water inlet end and a water outlet end between which a converging pipe, a throat pipe and a diverging pipe are connected in turn; a liquefied chlorine input port located below a middle part of the throat pipe and connecting with the throat pipe via a cone-shaped valve seat which is the last gate of liquefied chlorine being introduced into the throat pipe; a normally closed cone-shaped valve rod which is mounted over the cone-shaped valve seat and inserted into the throat pipe through a vertical circular hole on a top of the chlorination machine body, and moves up and down under the control of a pulsating electromagnetic executive mechanism to open/close the liquefied chlorine input port; wherein the pulsating electromagnetic executive mechanism adjusts amount of introduced chlorine in time via a residual chlorine current signal circuitry varying electric duct ratio at any moment.

2. The pulsating chlorination machine as claimed in claim 1, wherein the normally closed cone-shaped valve rod only stops at a highest position and a lowest position; when the pulsating electromagnetic executive mechanism is switched on, a cone-shaped end of the normally closed cone-shaped valve rod stays at the highest position to open the liquefied chlorine input port; and when the pulsating electromagnetic executive mechanism is switched off, the cone-shaped end of the normally closed cone-shaped valve rod stays at the lowest position to close the liquefied chlorine input port.

3. The pulsating chlorination machine as claimed in claim 2, wherein the cone-shaped valve seat connects the liquefied chlorine input port with the throat pipe and matches the cone-shaped end of the normally closed cone-shaped valve rod in shape.

4. The pulsating chlorination machine as claimed in claim 2, wherein when the cone-shaped end of the normally closed cone-shaped valve rod stays at the lowest position, two arc-shaped water passage cross sections are formed at both sides of the normally closed cone-shaped valve rod, respectively, and a setting principle of the highest position of the normally closed cone-shaped valve rod is that a conical tip of the normally closed cone-shaped valve rod is located at a proper position below a top end of a circular water passage cross section in the throat pipe.

5. The pulsating chlorination machine as claimed in claim 3, wherein when the cone-shaped end of the normally closed cone-shaped valve rod stays at the lowest position, two arc-shaped water passage cross sections are formed at both sides of the normally closed cone-shaped valve rod, respectively, and a setting principle of the highest position of the normally closed cone-shaped valve rod is that a conical tip of the normally closed cone-shaped valve rod is located at a proper position below a top end of a circular water passage cross section in the throat pipe.

6. The pulsating chlorination machine as claimed in claim 4, wherein the pulsating electromagnetic executive mechanism disposes a damping device therein.

7. The pulsating chlorination machine as claimed in claim 5, wherein the pulsating electromagnetic executive mechanism connects with an electric duct ratio automatic control adjustor which has a manual knob for setting electric duct ratio, and the pulsating electromagnetic executive mechanism and the electric duct ratio automatic control adjustor are integrally formed with each other in batch production.

8. The pulsating chlorination machine as claimed in claim 6, wherein the liquefied chlorine input port connects with a liquefied chlorine pipeline for chlorination machine inlet on which a check valve is mounted.

9. The pulsating chlorination machine as claimed in claim 1, wherein a gland packing ring is disposed surround the normally closed cone-shaped valve rod in the passage.

10. The pulsating chlorination machine as claimed in claim 2, wherein a gland packing ring is disposed surround the normally closed cone-shaped valve rod in the passage.
